(19) United States
(12) Patent Application Publication
(10) Pub. No.: US 2017/0286548 A1
(43) Pub. Date: Oct. 5, 2017

(54) SEARCH ENGINE POWERED SOFTWARE HELP

(71) Applicant: Microsoft Technology Licensing, LLC, Redmond, WA (US)

(72) Inventors: Soumik De, Hyderabad (IN); Shabbar Husain, Hyderabad (IN); Jatin Kakkar, Hyderabad (IN); Puspendra Kumar, Hyderabad (IN); William J. Pardi, Edgewood, WA (US); Subrata Roychoudhuri, Hyderabad (IN)

(21) Appl. No.: 15/088,962

(22) Filed: Apr. 1, 2016

(51) Int. Cl. G06F 17/30

(52) U.S. Cl. CPC G06F 17/30867; G06F 17/30554; G06F 17/30528; G06F 17/30398

(57) ABSTRACT

Systems, methods, and computer-readable storage media are provided for integrating native software help content with content from other data sources (e.g., community and/or expert sources). When a user signals that they'd like to engage a software help resource from one of various entry points within the software, the user is redirected to a search engine and a partial search query is formulated based upon perceived user intent and context within the software application. At least one attribute of a computing ecosystem associated with the user computing device is appended to the partial search query to create a complete search query and the complete search query is supplied to the search engine. The native help authority is integrated with contextual web results and both are presented to the user.

### BACKGROUND

Most available software programs include a native help function (for instance, initiated upon selection of the “F1” key in the Windows™ software program available from Microsoft Corporation of Redmond, Wash.) that is integrated and shipped as part of a particular product. The idea behind native software help is to aid the user in learning about the product, as well as to troubleshoot issues when there is an error. However, traditional native software help suffers from a number of shortcomings. First, the content is mostly static and cannot keep up with ever-changing help demands. Second, traditional native help does not take context into account when providing information, but instead merely relies upon a help query submitted by the user (for instance, derived from the entry point at which the user invoked the help function). Further, a finite number of help topics are covered in native help and, accordingly, the help topics are unable to provide meaningful answers to a number of less frequent user challenges. Still further, community (e.g., other users that may have encountered a similar issue in the past) or expert sources are not utilized in providing information in response to a help request.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for integrating native software help content with content from other data sources (e.g., community and/or expert sources). When a user signals that they'd like to engage a software help resource from one of various entry points within the software (for instance, when the user selects the “F1” key upon utilizing the Windows™ software), the user is redirected to a search engine and a partial search query is formulated based upon perceived user intent (e.g., taking into account the feature of the software program that the user was utilizing when the help request was made) and context within the software application (e.g., the location in the software program from which the help request was made). At least one attribute of a computing ecosystem associated with the user computing device is appended to the partial search query to create a complete search query and the complete search query is supplied to the search engine. The native help authority (that is, content supplied by the developer of the software) is integrated with contextual web results and both are presented to the user. In embodiments, personalizations based upon user preferences, past behavior, and the like (e.g., a user may be known to prefer to receive mixed media information rather than text-based documents, etc.) also are taken into account when providing results to an inquiring user.

Embodiments hereof provide the user with the information traditional native help would have provided, as well as search results from the search engine that take into account community and expert sources. In this way, user satisfaction with the help content received is more likely to be satisfactory to the user than traditional static and limited help content.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a diagram depicting an exemplary computing environment for providing integrated and meaningful aid in response to a software help request, in accordance with an aspect of the technology described herein;

FIG. 3 is a flow diagram depicting a method for providing integrated and meaningful aid in response to a software help request, in accordance with an aspect of the technology described herein; and

FIG. 4 is a flow diagram depicting another method for providing integrated and meaningful aid in response to a software help request, in accordance with an aspect of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for integrating native software help content with content from other data sources (e.g., community and/or expert sources). When a user signals that they'd like to engage a software help resource from one of various entry points within the software (for instance, when the user selects the “F1” key upon utilizing the Windows™ software), the user is redirected to a search engine and a partial search query is formulated based upon perceived user intent (e.g., taking into account the feature of the software program that the user was utilizing when the help request was made) and context within the software application (e.g., the location in the software program from which the help request was made). At least one attribute of a computing ecosystem associated with the user computing device is appended to the partial search query to create a complete search query and the complete search query is supplied to the search engine. The native help authority (that is, content supplied by the developer of the software) is integrated with contextual web results and both are presented to the user. In embodiments, personalizations based upon user preferences, past behavior, and the like (e.g., a user may be known to prefer to receive mixed media information rather than text-based documents, etc.) also are taken into account when providing results to an inquiring user.

In accordance with embodiments hereof, users are provided with the information traditional native help would have provided, as well as search results from the search engine that take into account community and expert sources. In this way, user satisfaction with the help content received is more likely to be satisfactory to the user than traditional static and limited help content.

Accordingly, exemplary embodiments are directed to systems for generating search queries to aid in identifying help content pertaining to a software application running on a user computing device. Exemplary systems comprise a help request receiving component; a partial search query determining component, a query appending component, a query initiating component, a help content identifying component, and a presenting component. The help request receiving component is configured to receive a help request from the user computing device, the help request including information associated with a nature of the help request and at least one attribute associated with a computing ecosystem of the user computing device and with the nature of the help request. The partial search query determining component is configured to determine a partial search query associated with the received help request. The query appending component is configured to append the partial search query with the at least one attribute to create a complete search query. The query initiating component is configured to initiate the complete search query against a search-related data store. The help content identifying component is configured to identify, from the search-related data store, dynamic help content authored by a developer of the software application and help content authored by a source other than the developer of the software application. The presenting component is configured to present the dynamic help content authored by the developer of the software application and the help content authored by the source other than the developer of the software application in association with the user computing device.

Other exemplary embodiments are directed to methods (for instance, being performed by one or more computing devices including at least one processor) for generating search queries to aid in identifying help content pertaining to a software application running on a user computing device. Exemplary methods comprise receiving a help request from the user computing device; looking up in a data store a partial search query associated with the received help request; receiving at least one attribute associated with a computing ecosystem associated with the user computing device; appending the partial search query with information pertaining to the at least one attribute to create a complete search query; initiating the complete search query against a search-related data store; from the search-related data store, identifying dynamic help content authored by a developer of the software application and help content authored by a source other than the developer of the software application; and presenting the dynamic help content authored by the developer of the software application and the help content authored by the source other than the developer of the software application in association with the user computing device.

Yet other exemplary embodiments are directed to one or more computer-readable storage media storing computer-useable instructions that, when used by one or more computing devices, cause the one or more computing devices to perform a method for generating search queries to aid in identifying help content pertaining to a software application running on a user computing device. Exemplary methods comprise receiving a help request from the user computing device, the help request including information associated with a nature of the help request and at least one attribute associated with a computing ecosystem of the user computing device and with the nature of the help request; looking up in a first data store a partial search query associated with the received help request; receiving, from the user computing device, at least one attribute associated with a computing ecosystem associated with the user computing device; appending the partial search query with information pertaining to the at least one attribute to create a complete search query; initiating the complete search query against a second data store; identifying help content authored by a developer of the software application and help content authored by a source other than the developer of the software application; and presenting the help content authored by the developer of the software application and help content authored by the source other than the developer of the software application in association with the user computing device.

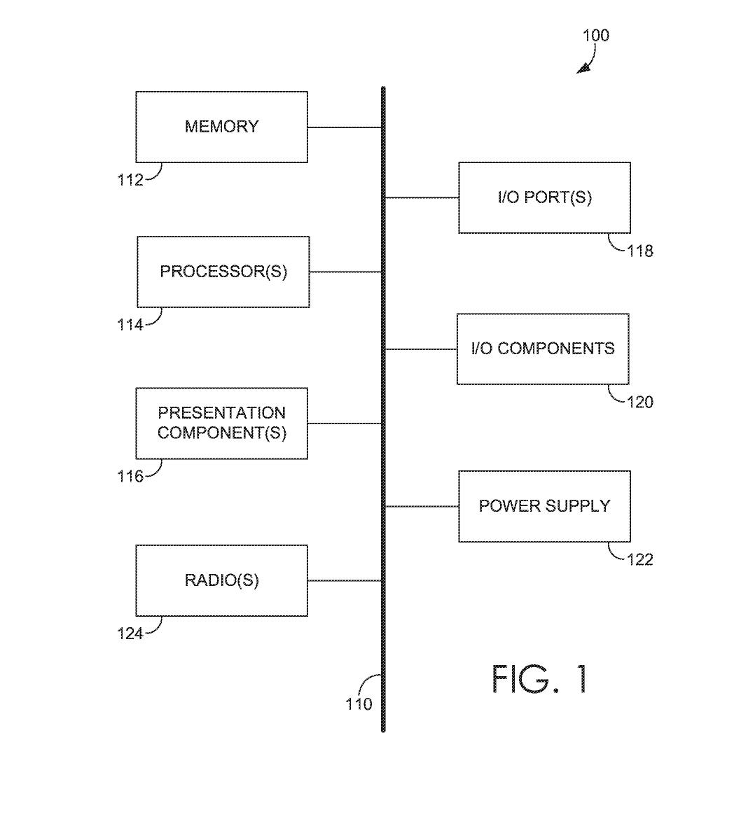

Referring now to the figures in general and initially to FIG. 1 in particular, an exemplary operating environment for implementing embodiments of the present technology is shown and designated generally as computing device 100. The computing device 100 is but one example of a suitable computing environment and is not intended to suggest any limitation as to the scope of use or functionality of embodiments of the technology. Neither should the computing device 100 be interpreted as having any dependency or requirement relating to any one component nor any combination of components illustrated.

Embodiments of the technology may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the technology may be practiced in a variety of system configurations, including, but not limited to, hand-held devices, consumer electronics, general-purpose computers, more specialty computing devices, and the like. Embodiments of the technology also may be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventor hereof recognizes that such is the nature of the art, and reiterates that the diagram of FIG. 1 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors 114 that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 114 may be direct or via a coupling utilizing a serial port, parallel port, and/or other interface and/or system bus known in the art. Furthermore, the digitizer input component may be a component separate from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 100. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

The computing device 100 additionally may include a radio 124. The radio 124 transmits and receives radio communications. The computing device 100 may be a wireless terminal adapted to receive communications and media over various wireless networks. The computing device 100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When referring to “short” and “long” types of connections herein, reference to the spatial relation between two devices is not intended. Instead, short range and long range are generally being referred to as different categories, or types, of connections (i.e., a primary connection and a secondary connection). A short-range connection may include a Wi-Fi® connection to a device (e.g., a mobile hotspot) that provides access to a wireless communications network, such as a WLAN connection using the 802.11 protocol. A Bluetooth® connection to another computing device is a second example of a short-range connection. A long-range connection may include a connection using one or more of CDMA, GPRS, GSM, TDMA, and 802.16 protocols.

Aspects of the subject matter detailed herein may be described in the general context of computer-executable instructions, such as program modules, being executed by an electronic device. Generally, program modules include routines, programs, objects, components, data structures, and so forth, which perform particular tasks or implement particular abstract data types. Aspects of the subject matter described herein also may be practiced in distributed computing environments where tasks are performed by remote processing devices that are linked through a communications network. In a distributed computing environment, program modules may be located in both local and remote computer storage media including memory storage devices. The computer-useable instructions form an interface to allow a computing device to react according to a source of input. The instructions cooperate with other code segments to initiate a variety of tasks in response to data received in conjunction with the source of the received data.

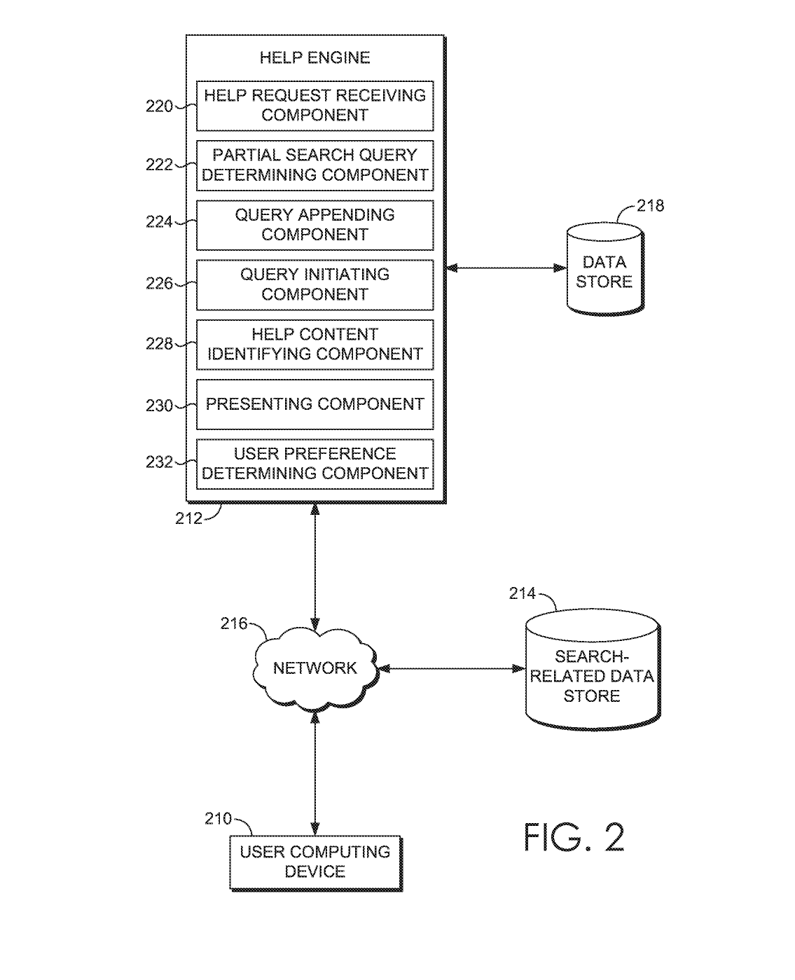

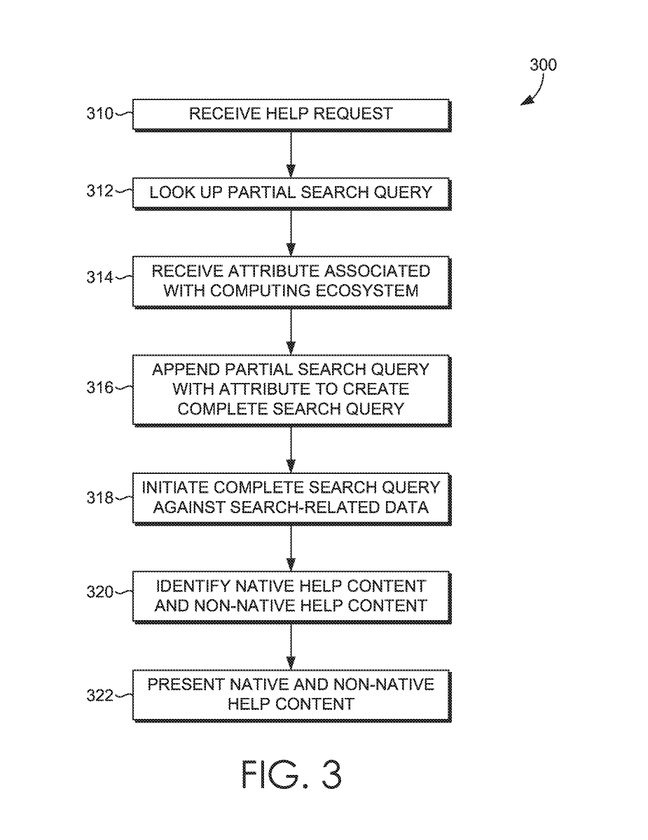

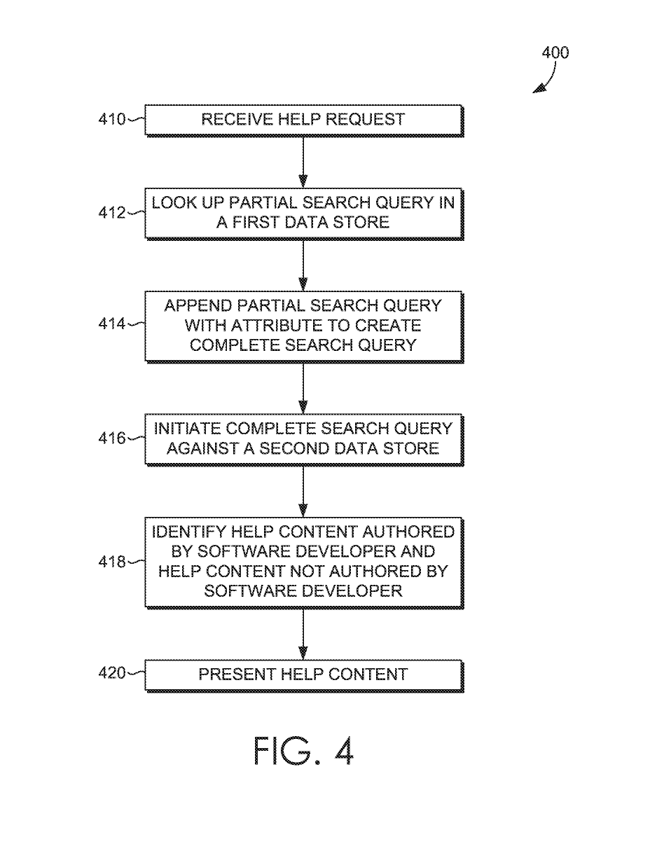

As previously set forth, embodiments of the present invention provide systems, methods, and computer-readable storage media for integrating native software help content with content from other data sources, specifically, data sources associated with a search-related data store. With reference to FIG. 2, a block diagram is provided illustrating an exemplary computing system 200 in which embodiments of the present technology may be employed. Generally, the computing system 200 illustrates an environment in which search queries may be generated to aid in identifying help content pertaining to a software application running on a user computing device, in accordance with the methods, for instance, illustrated in FIGS. 3 and 4 (more fully described below). Among other components not shown, the computing system 200 generally includes a user computing device 210, a help engine 212, and a search-related data store 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of user computing devices 210 and/or help engines 212 may be employed in the computing system 200 within the scope of embodiments of the present technology. Each may comprise a single device/interface or multiple devices/interfaces cooperating in a distributed environment. For instance, the help engine 212 may comprise multiple devices and/or modules arranged in a distributed environment that collectively provide the functionality of the help engine 212 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the help engine 212 or as an Internet-based service. It will be understood by those having ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of help engines 212. By way of example only, the help engine 212 might be provided as a single computing device, a cluster of computing devices, or a computing device remote from one or more of the remaining components.

It should be understood that this and other arrangements described herein are set forth only as examples. Other arrangements and elements (e.g., machines, interfaces, functions, orders, and groupings of functions) can be used in addition to or instead of those shown and/or described, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the computing device 110 is associated with a microphone for accepting dictated input and one or more I/O components, such as a stylus or keypad, for permitting alpha-numeric and/or textual input into a designated region (e.g., text box).

A computing device associated with the help engine 212 may include any type of computing device, such as, e.g., the computing device 100 described with reference to FIG. 1. It should be noted that the functionality described herein as being performed by the help engine 212 may be performed by any other application, application software, user interface, or the like capable of generating and initiating search queries to aid in identifying help content pertaining to a software application running on a user computing device. It should further be noted that embodiments of the present technology are equally applicable to mobile computing devices and devices accepting gesture, touch and/or voice input. Any and all such variations, and any combination thereof, are contemplated to be within the scope of embodiments of the present technology.

The help engine 212 of the computing system 200 of FIG. 2 is configured to, among other things, generate and initiate search queries to aid in identifying help content related to software applications running on the user computing device 210. As illustrated, the help engine 212 has access to a search-related data store 214. The search-related data store 214 is configured to store information related to, by way of example only, received search queries, user click data, dynamic help content authored by software developers, static help content authored by software developers, help content authored by software experts, help content authored by communities supporting various software programs, user-stated preferences, user-inferred preferences, prior user behavior, and the like. To the extent user behavior patterns and the like that are specific to one or more users are stored in association with the data store 214, such user(s) may be permitted to consent to such data collection, in accordance with embodiments hereof. For instance, prior to collection of user-specific data, notice may be provided informing the user that such data will be collected unless s/he opts out of such collection. Alternatively, the user may be asked to take affirmative action to consent to collection (i.e., to opt-in) before such data is collected. Any and all such variations, and any combination thereof, are contemplated to be within the scope of aspects of the present technology.

In embodiments, the data store 214 is configured to be searchable for one or more of the items stored in association therewith. It will be understood and appreciated by those having ordinary skill in the art that the information stored in association with the data store 214 may be configurable and may include any information relevant to, by way of example only, software program help content, user preferences, and the like. The content and volume of such information are not intended to limit the scope of aspects of the present technology in any way. Further, the data store 214 may be a single, independent component (as shown) or a plurality of storage devices, for instance a database cluster, portions of which may reside in association with the help engine 212, another external computing device (not shown), and/or any combination thereof. Additionally, the data store 214 may include a plurality of unrelated data stores within the scope of embodiments of the present technology.

As illustrated, the help engine 212 includes a help request receiving component 220, a partial search query determining component 222, a query appending component 224, a query initiating component 226, a help content identifying component 228, a presenting component 230, and a user preference determining component 232. The help request receiving component 220 is configured to, among other things, receive a help request initiated by a user, for instance, a user associated with the user computing device 210. In embodiments, the help request may include one or more of information pertaining to a feature of the software application that is associated with receipt of the help request and a location within the software application from which the help request was received.

The partial search query determining component 222 is configured to, among other things, determine a partial search query associated with the received help request. In embodiments, the partial search query may be determined by looking up information associated with the help request (e.g., information pertaining to a feature of the software application that is associated with receipt of the help request and/or a location within the software application from which the help request was received) in a data store that maps such information to partial search queries, for instance, in a look-up table. As illustrated, the partial search query determining component 222 may look up the partial search query in the data store 218. The data store 218 is configured to store, by way of example only, look-up tables associated with partial search queries. In embodiments, the data store 218 is configured to be searchable for one or more of the items stored in association therewith. It will be understood and appreciated by those having ordinary skill in the art that the information stored in association with the data store 218 may be configurable and may include any information relevant to, by way of example only, partial search queries, possible help request features, possible help request locations, and the like. The content and volume of such information are not intended to limit the scope of aspects of the present technology in any way. Further, the data store 218 may be a single, independent component (as shown) or a plurality of storage devices, for instance a database cluster, portions of which may reside in association with the help engine 212, another external computing device (not shown), and/or any combination thereof. Additionally, the data store 218 may include a plurality of unrelated data stores within the scope of embodiments of the present technology.

The query appending component 224 is configured to, among other things, receive at least one attribute associated with a computing ecosystem of the user computing device and append the partial search query with the at least one attribute to create a complete search query. A “computing ecosystem,” as the term is utilized herein, refers to devices, programs, and the like that are accessible to and/or integrated with the user computing device. For instance, at attribute of a computing ecosystem may include a make/model of printer, printer driver, microphone, scanner, monitor, or the any other device, program, etc. that may be utilized by the user computing device. Generally, an attribute received by the query appending component 224 will be relevant to the received help request. By way of example, a help request received from the printer portion of the control panel of the Windows™ software application may be appended with information pertaining to the printer driver associated with the user computing device as it is likely the user is inquiring about something pertaining to the printer.

The query initiating component 226 is configured to, among other things, initiate the complete query against a data store. In embodiments, the query is initiated against a search-related data store, for instance, the search-related data store 214.

The help content identifying component 228 is configured to, among other things, identify help content related to the complete search query. In embodiments native help content, that is, help content authored by a developer of the software application may be identified. (It will be understood and appreciated by those having ordinary skill in the art that reference to the developer of a software application refers not only to the entity actually responsible for the software development but those authorized to provide content on behalf of the actual developer or developers.) In accordance with embodiments of the present technology, native help content may be dynamic such that it may be altered or updated as the developer sees fit. In embodiments, a pipeline may be provided in association with the help engine 212 for developers to update the web-based content.

In embodiments, non-native help content, that is, help content authored by a source other than the developer of the software application may be identified by the help content identifying component 228. Such content may include, by way of example only, content provided by experts in the subject software application and/or content provided by a community that supports (e.g., discusses) the subject software application.

The presenting component 230 is configured to, among other things, transmit the identified help content for presentation in association with the user computing device 210.

In embodiments of the present technology, personalizations based upon user preferences, past behavior, and the like may be taken into account in identifying and presenting help content. In that regard, the user preference determining component 232 is configured to, among other things, determine user preferences that are relevant to the identification and presentation of content. For instance, a user of the user computing device 210 may be known to prefer to receive mixed media information rather than text-based documents. In this instance, the user preference determining component 232 may be configured to determine such user preference and provide such information in association with initiation of the complete search query so that mixed media results will be given preference over text-based results.

Turning now to FIG. 3, an exemplary flow diagram illustrating a method 300 for generating search queries to aid in identifying help content pertaining to software applications running on a user computing device is depicted. As indicated at block 310, a help request is received from a user computing device (for instance, by the help request receiving component 220 of the help engine 212 of FIG. 2). In embodiments, the help request may include one or more of a feature of the software application that is associated with receipt of the help request and a location within the software application from which the help request was received. As indicated at block 312, a partial search query associated with the received help request is looked up in a data store, for instance, the data store 218 associated with the help engine 212 of FIG. 2. In embodiments, the partial search query is looked up in the data store utilizing information about one or more of a feature of the software application that is associated with receipt of the help request and a location within the software application from which the help request was received.

As indicated at block 314, at least one attribute associated with a computing ecosystem of the user computing device is received and the partial search query is appended with information pertaining to the at least one attribute to create a complete search query, as indicated at block 316. Receipt of the at least one attribute and appending of the partial search query may be performed, for instance, by the query appending component 224 of the help engine 212 of FIG. 2. As indicated at block 318, the complete search query is initiated against a search-related data store (e.g., the search-related data store 214 of FIG. 2). As indicated at block 320, native help content (for instance, dynamic help content authored by a developer of the software application) and non-native help content (for instance, help content authored by a source other than the developer of the software application) is identified (e.g., by the help content identifying component 228 of the help engine 212 of FIG. 2). As indicated at block 322, the native help content and the non-native help content are presented in association with the user computing device (e.g., by the presenting component 230 of the help engine 212 of FIG. 2).

With reference to FIG. 4, an exemplary flow diagram illustrating another method 400 for generating search queries to aid in identifying help content pertaining to software applications running on a user computing device is depicted. As indicated at block 410, a help request is received from a user computing device (for instance, by the help request receiving component 220 of the help engine 212 of FIG. 2). The help request includes information associated with a nature of the help request (e.g., a feature of the software application that is associated with receipt of the help request and/or a location within the software application from which the help request was received) and at least one attribute associated with a computing ecosystem of the user computing device and with the nature of the help request. As indicated at block 412, a partial search query associated with the received help request is looked up in a first data store, for instance, the data store 218 associated with the help engine 212 of FIG. 2. In embodiments, the partial search query is looked up in the data store utilizing information about the nature of the help request.

As indicated at block 414, the partial search query is appended with information pertaining to the at least one attribute to create a complete search query. Receipt of the at least one attribute and appending of the partial search query may be performed, for instance, by the query appending component 224 of the help engine 212 of FIG. 2. As indicated at block 416, the complete search query is initiated against a second data store (e.g., the search-related data store 214 of FIG. 2). As indicated at block 418, help content authored by a developer of the software application and help content authored by a source other than the developer of the software application is identified (e.g., by the help content identifying component 228 of the help engine 212 of FIG. 2). As indicated at block 320, the help content authored by the developer of the software application and the help content authored by the source other than the developer of the software application are presented in association with the user computing device (e.g., by the presenting component 230 of the help engine 212 of FIG. 2).

It will be understood and appreciated by those having ordinary skill in the art that the above description is merely exemplary and is not meant to limit the scope of embodiments of the subject technology in any way. The description is offered merely to enhance the reader's understanding of various aspects that may be incorporated into systems and methods in accordance with the technology described herein.

While specific elements and steps are discussed in connection to one another, it is understood that any element and/or steps provided herein is contemplated as being combinable with any other elements and/or steps regardless of explicit provision of the same while still being within the scope provided herein. Since many possible aspects may be made of the disclosure without departing from the scope thereof, it is to be understood that all matter herein set forth or shown in the accompanying drawings is to be interpreted as illustrative and not in a limiting sense.

What is claimed is:

1. A system for generating search queries to aid in identifying help content pertaining to a software application running on a user computing device, the system comprising:
a help request receiving component that receives a help request from the user computing device, the help request including information associated with a nature of the help request and at least one attribute associated with a computing ecosystem of the user computing device and with the nature of the help request;
a partial search query determining component that determines a partial search query associated with the received help request;
a query appending component that appends the partial search query with the at least one attribute to create a complete search query;
a query initiating component that initiates the complete search query against a search-related data store;
a help content identifying component that, from the search-related data store, identifies dynamic help content authored by a developer of the software application and help content authored by a source other than the developer of the software application; and
a presenting component that presents the dynamic help content authored by the developer of the software application and the help content authored by the source other than the developer of the software application in association with the user computing device.

2. The system of claim 1, wherein the nature of the help request includes a feature of the software application that is associated with receipt of the help request.

3. The system of claim 1, wherein the nature of the help request includes a location within the software application from which the help request is received.

4. The system of claim 1, wherein the help content authored by the source other than the developer of the software application is associated with an expert associated with the software application.

5. The system of claim 1, wherein the help content authored by the source other than the developer of the software application is associated with a community that supports the software application.

6. The system of claim 1, further comprising a preference determining component that determines at least one preference associated with the user computing device, wherein the presenting component presents at least one of the dynamic help content authored by the developer of the software application and the help content authored by the source other than the developer of the software application in association with the user computing device and in accordance with the at least one preference.

7. A method being performed by one or more computing devices including at least one processor, the method for generating search queries to aid in identifying help content pertaining to a software application running on a user computing device, the method comprising:
receiving a help request from the user computing device;
looking up in a data store a partial search query associated with the received help request;
receiving at least one attribute associated with a computing ecosystem associated with the user computing device;
appending the partial search query with information pertaining to the at least one attribute to create a complete search query;
initiating the complete search query against a search-related data store;
from the search-related data store, identifying dynamic help content authored by a developer of the software application and help content authored by a source other than the developer of the software application; and
presenting the dynamic help content authored by the developer of the software application and the help content authored by the source other than the developer of the software application in association with the user computing device.

8. The method of claim 7, wherein the help request includes information about a feature of the software application that is associated with receipt of the help request.

9. The method of claim 7, wherein the help request includes information about a location within the software application from which the help request is received.

10. The method of claim 7, wherein the help content authored by the source other than the developer of the software application is associated with an expert associated with the software application.

11. The method of claim 7, wherein the help content authored by the source other than the developer of the software application is associated with a community that supports the software application.

12. The method of claim 7, further comprising:
determining at least one preference associated with the user computing device; and
presenting at least one of the dynamic help content authored by the developer of the software application and the help content authored by the source other than the developer of the software application in association with the user computing device and in accordance with the at least one preference.

13. One or more computer storage media storing computer-useable instructions that, when used by one or more computing devices, cause the one or more computing devices to perform a method for generating search queries to aid in identifying help content pertaining to a software application running on a user computing device, the method comprising:
receiving a help request from the user computing device, the help request including information associated with a nature of the help request and at least one attribute associated with a computing ecosystem of the user computing device and with the nature of the help request;
looking up in a first data store a partial search query associated with the received help request;
appending the partial search query with information pertaining to the at least one attribute to create a complete search query;
initiating the complete search query against a second data store;
identifying help content authored by a developer of the software application and help content authored by a source other than the developer of the software application; and
presenting the help content authored by the developer of the software application and help content authored by the source other than the developer of the software application in association with the user computing device.

14. The one or more computer storage media of claim 13, wherein the nature of the help request includes a feature of the software application that is associated with receipt of the help request.

15. The one or more computer storage media of claim 13, wherein the nature of the help request includes a location within the software application from which the help request is received.

16. The one or more computer storage media of claim 13, wherein the help content authored by the source other than the developer of the software application is associated with an expert associated with the software application.

17. The one or more computer storage media of claim 13, wherein the help content authored by the source other than the developer of the software application is associated with a community that supports the software application.

18. The one or more computer storage media of claim 13, wherein the method further comprises:
determining at least one preference associated with the user computing device; and
presenting at least one of the help content authored by the developer of the software application and the help content authored by the source other than the developer of the software application in association with the user computing device and in accordance with the at least one preference.

19. The one or more computer storage media of claim 13, wherein the second data store includes search-related data.

20. The one or more computer storage media claim 13, wherein the help content authored by the developer of the software application is dynamic.
